(19) United States
(12) Patent Application Publication
(10) Pub. No.: US 2011/0132570 A1
(43) Pub. Date: Jun. 9, 2011

(54) COMPOUND GEOMETRY HEAT EXCHANGER FIN

(76) Inventor: George E. Wilmot, East Granby, CT (US)

(21) Appl. No.: 12/633,158

(22) Filed: Dec. 8, 2009

(51) Int. Cl. F28F 3/12; B60H 1/00

(52) U.S. Cl. 165/41; 165/164; 165/169

(57) ABSTRACT

A compound heat exchanger includes a plurality of adjacent, continuous fins. Each fin defines a channel having an associated fin axis. A first portion of each channel extends along the axis, and a second portion of each channel is tortuous in opposing directions about the axis.

### BACKGROUND OF THE INVENTION

This application relates to cooling, and more specifically to a compound geometry heat exchanger fin.

A heat exchanger is a device used to transfer heat two mediums, and heat exchangers have been used in a variety of cooling systems to provide a heat transfer. In certain environments, such as aircraft environments, a heat exchanger may be subjected to an extreme variety of temperatures and environmental conditions (e.g. humidity and moisture), which can result in ice formation on heat exchanger fins.

### SUMMARY OF THE INVENTION

A compound heat exchanger includes a plurality of adjacent, continuous fins. Each fin defines a channel having an associated fin axis. A first portion of each channel extends along the axis, and a second portion of each channel is tortuous in opposing directions about the axis.

An aircraft cooling configuration includes a plurality rows of adjacent, continuous first fins, each first fin defining a channel having an associated first axis. A portion of each first channel extends along the axis, and a portion of each first channel is tortuous in opposing directions about the axis. The configuration further includes a plurality of rows of adjacent continuous second fins, each second fin defining a second channel that extends along an associated second axis, each second axis being transverse to each first axis. A turbine is operable to provide a flow of air through the plurality of first fins to cool a fluid flowing through the plurality of second fins.

These and other features of the present invention can be best understood from the following specification and drawings, the following of which is a brief description.

### BRIEF DESCRIPTION OF THE DRAWINGS

FIG. 1 schematically illustrates an aircraft cooling configuration.

FIG. 2 schematically illustrates a prior art heat exchanger.

FIG. 2a schematically illustrates a magnified view of the prior art heat exchanger.

FIG. 3 schematically illustrates an improved novel heat exchanger.

FIG. 4 schematically illustrates channels defined by the heat exchanger of FIG. 3.

FIG. 5 schematically illustrates additional channels defined by the heat exchanger of FIG. 3.

### DETAILED DESCRIPTION OF THE PREFERRED EMBODIMENT

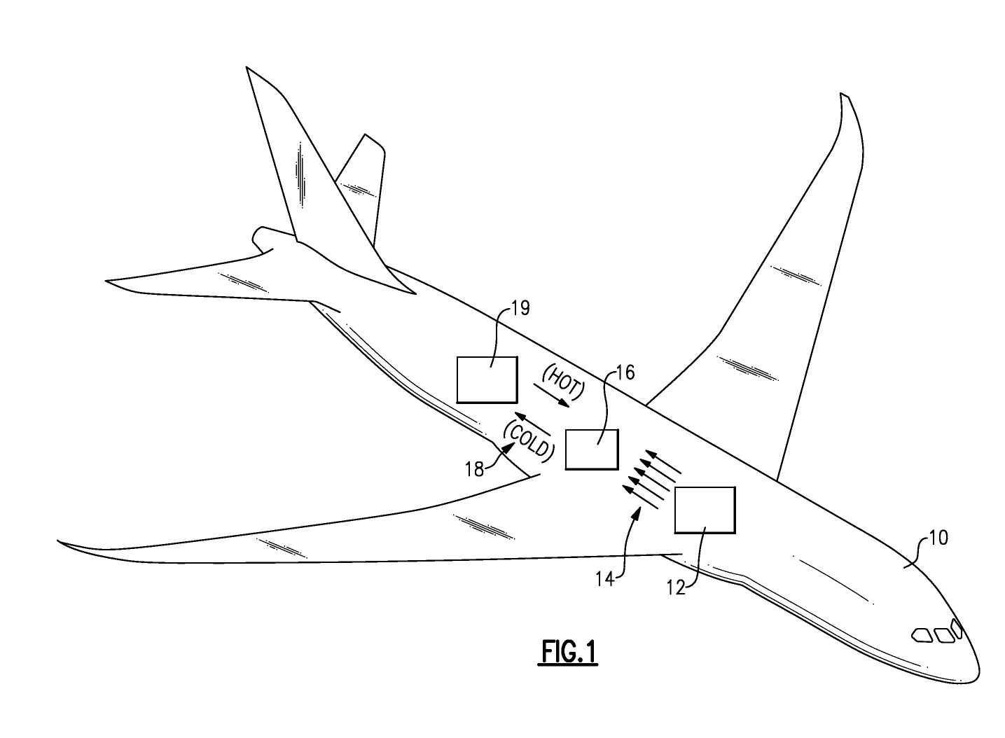

FIG. 1 schematically illustrates a cooling configuration for an aircraft 10. A turbine 12 creates a flow of air 14 that is applied to a heat exchanger 16 to cool a flow of transport fluid 18. The transport fluid 18 is distributed to cool a load 19, which may include an aircraft HVAC system and an aircraft food refrigeration system, for example. The transport fluid 18 then returns to the heat exchanger 16 to be re-cooled, and the cycle repeats.

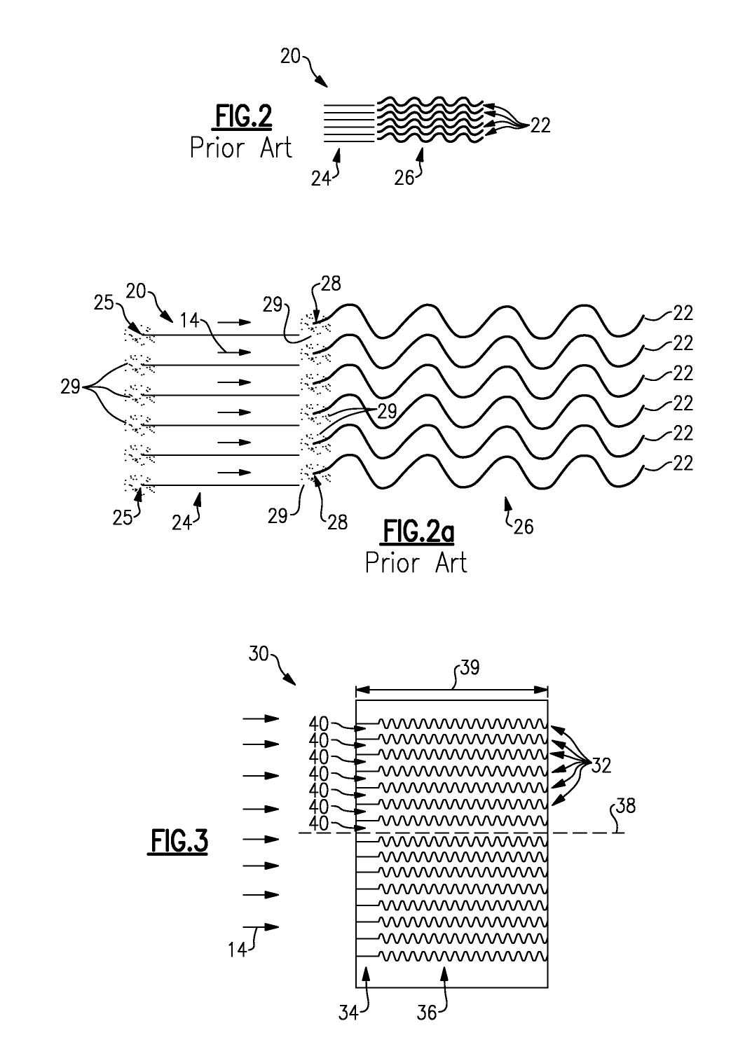

FIG. 2 schematically illustrates a prior art heat exchanger 20 that includes a plurality of fins 22 each having a flat, inlet portion 24 that is physically separated from and a curved, outlet portion 26. As air 14 flows along the fins 22, the air strikes a leading edge 25 of each inlet portion 24 and also strikes a leading edge 28 of each fin 22, resulting in a formation of ice 29 on the leading edges 25, 28. The ice 29, particularly the ice at the leading edge 28, obstructs the flow of air 14 over the fins, minimizing efficiency of the heat exchanger 20.

FIG. 3 schematically illustrates an improved heat exchanger 30 that includes a plurality of continuous fins 32. Each continuous fin 32 defines a channel 40 that extends along a channel axis (see, e.g., axis 38). A first portion 34 of each channel 40 extends along its channel axis, and a second curved portion 36 of each channel 40 is tortuous in opposing directions about its axis 38. Unlike the prior art fins 22, the fins 32 are continuous between portions 34, 36 such that ice formation is minimized at the junction of the portions 34, 36, which facilitates greater air flow and consequently greater efficiency. The second curved portion 36 is somewhat sinusoidal. However, it is understood that the curved portion 36 does not have to actually be purely sinusoidal, and may be only somewhat sinusoidal.

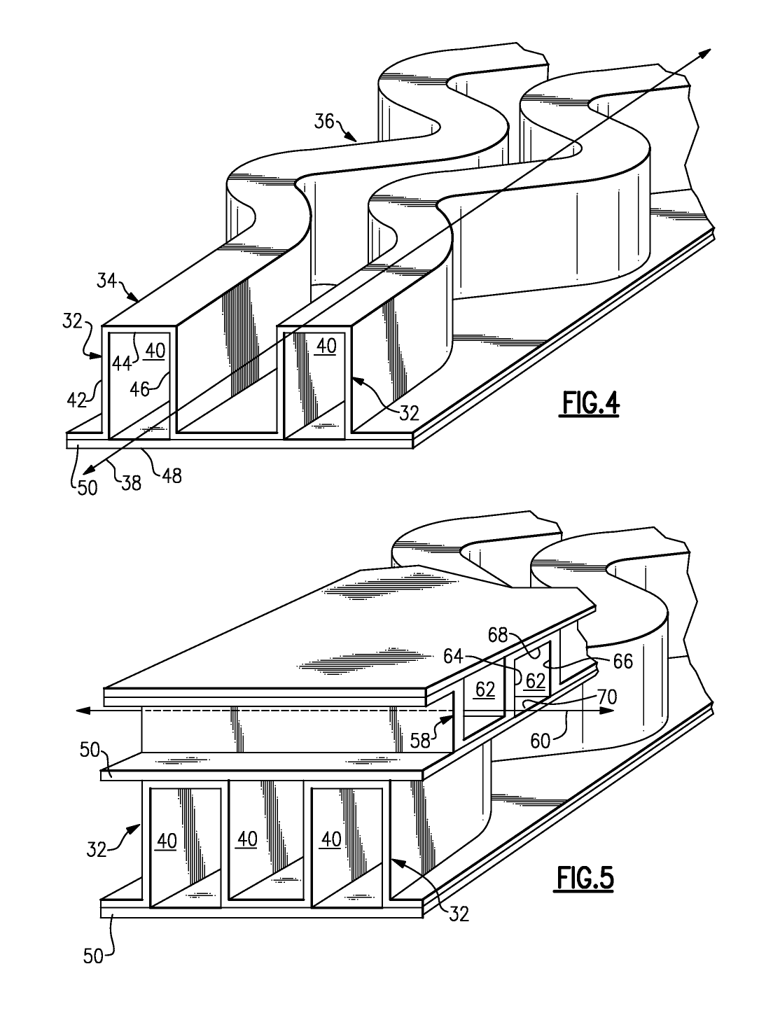

FIG. 4 schematically illustrates a second view of the heat exchanger fins 32 of FIG. 3. As shown in FIG. 4, each fin 32 defines a channel 40. Each channel 40 is defined by a first wall 42, a second wall 46, a third wall 44, and a fourth wall 48. One of the four walls 42-48 corresponds to a portion of a parting sheet. In the example of FIG. 4, the labeled fourth wall 48 is the parting sheet wall. However due to the stepped formation of the fins 32, in adjacent channels, it would be the second wall 44 that is the parting sheet wall, and this would alternate every other channel. Each channel 40 has a portion 34 that extends along its channel axis 38, and a portion 36 that is tortuous in opposing directions about the channel axis 38. In the portion 34 of each channel 40, four walls 42-48 are parallel to the axis 38, and in the portion 36 of each channel 40 the four walls 42-48 are no longer parallel to the axis.

Although only a single channel axis 38 is shown in FIGS. 3 and 4 it is understood that each individual channel 40 has its own individual channel axis about which each channel extends and is tortuous. In one example, a ratio of a length of the first portion 34 of the channel 40 to a length of the second portion 36 of the channel 40 is less than or equal to 1/10. Of course, other lengths and ratios could be used.

FIG. 5 schematically illustrates the heat exchanger fins 32 of FIG. 3 along with a plurality of transverse fins 58. The fins 58 define a plurality of channels 62. Each channel 62 is defined by a first wall 64, a second wall 66, a third wall 68, and a fourth wall 70. Each channel extends along a channel axis 60. One of the four walls 64-70 corresponds to a portion of a parting sheet 50. In the example of FIG. 4, the labeled fourth wall 70 is the parting sheet wall. However, due to the stepped formation of the fins 58, in adjacent channels, it would be the second wall 68 that is the parting sheet wall, and this would alternate every other channel.

In the example of FIG. 5, unlike the channels 40, the channels 62 do not have a tortuous portion. However, FIG. 5 is only an example, and it is understood that the channels 62 may or may not have a tortuous portion. Each axis 60 is transverse to each axis 38. Each channel 40 receives a flow of air 14, and each channel 62 receives a flow of the transport fluid 18 (see FIG. 1) such that the air 14 is operable to cool the transport fluid 18. In one example the fins 32, 58 and the parting sheets 50 are composed at least partially of aluminum, and the transport fluid includes propylene glycol. Of course, other materials and transport fluids could be used. The heat exchanger 30 may be described as a “compound heat exchanger” because it includes a plurality of fins 32, 58 and a plurality of fin channel sections 34, 36.

Although only a single layer of fins 32 and a single layer of fins 58 have been illustrated in FIG. 5, it is understood that the heat exchanger 30 could include a plurality of layers of fins 32, 58 such that the air-receiving fins 32 and transport fluid-receiving fins 58 are staggered in alternating layers and are separated by parting sheets 50. Also, although the heat exchanger 16 has been described in the context of an aircraft environment, it is understood that other applications would be possible, and that the aircraft environment is only exemplary.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A compound heat exchanger, comprising:
a plurality of adjacent, continuous fins, each fin defining a channel having an associated channel axis, wherein a first portion of each channel extends along the axis, and a second, curved portion of each channel is tortuous in opposing directions about the axis.

2. The compound heat exchanger of claim 1, wherein each channel is formed by a first wall, a second wall, a third wall, and a fourth wall, one of the four walls corresponding to a portion of a parting sheet.

3. The compound heat exchanger of claim 2, wherein the four walls are all at right angles to each other, and in the first portion of each channel the four walls are parallel to the axis, and in the second portion of each channel the four walls are no longer parallel to the axis.

4. The compound heat exchanger of claim 1, wherein the portion of each channel extending along the axis is an inlet for a flow of fluid, and the portion of each channel tortuous in opposing directions is an outlet for the fluid.

5. The compound heat exchanger of claim 1, wherein the plurality of continuous fins includes a plurality of rows of adjacent fins, each fin defining a channel having an associated channel axis, each of the channel axes being parallel.

6. The compound heat exchanger of claim 1, wherein a ratio of a length of the first portion of the channel to a length of the second portion of the channel is less than or equal to 1/10.

7. The compound heat exchanger of claim 1, wherein the plurality of continuous fins are a plurality of first continuous fins defining first channels extending along and being tortuous about first channel axes, the heat exchanger further comprising:
a plurality of second continuous fins, each of the plurality of second continuous fins defining a second channel extending along an associated second channel axis, each of the plurality of second channel axes being transverse to the first channel axes.

8. The compound heat exchanger of claim 7, wherein the plurality of rows of first fins are staggered such that each row of first fins is separated a second row of fins, the second row of fins being spaced from rows of first fins by at least one parting sheet.

9. The compound heat exchanger of claim 8, wherein the plurality of first fins, the plurality of second fins, and each parting sheet is composed at least partially of aluminum.

10. An aircraft cooling configuration, comprising:
a plurality rows of adjacent, continuous first fins, each first fin defining a first channel having an associated first axis, wherein a portion of each first channel extends along the axis, and a portion of each first channel is tortuous in opposing directions about the axis;
a plurality of rows of adjacent continuous second fins, each second fin defining a second channel that extends along an associated second axis, wherein each second axis is transverse to each first axis; and
a turbine operable to provide a flow of air through the plurality of rows of first fins to cool a fluid flowing through the plurality of rows of second fins.

11. The aircraft cooling configuration of claim 10, wherein the plurality of rows of first fins and the plurality of rows of second fins are staggered and are separated by parting sheets.

12. The aircraft cooling configuration of claim 11, wherein each first channel and each second channel are formed by a first wall, a second wall, a third wall, and a fourth wall, one of the four walls corresponding to a portion of the parting sheet.

13. The aircraft cooling configuration of claim 12, wherein the four walls are all at right angles to each other, and in the first portion of each first channel the four walls are parallel to the first axis, and in the second portion of each first channel the four walls are no longer parallel to the second axis.
